(19) United States
(12) Patent Application Publication
(10) Pub. No.: US 2025/0033435 A1
(43) Pub. Date: Jan. 30, 2025

(54) CABIN AIR CONTROL SYSTEM WITH SINGLE ADSORPTION UNIT

(71) Applicant: MANN+HUMMEL GmbH, Ludwigsburg (DE)

(72) Inventors: Jon CHAI, Zhongwei (CN); Lei WU, Shanghai (CN)

(21) Appl. No.: 18/677,839

(22) Filed: May 29, 2024

Related U.S. Application Data
(63) Continuation of application No. PCT/CN2023/109261, filed on Jul. 26, 2023.

(51) Int. Cl. B60H 1/32; B60H 1/22

(52) U.S. Cl. CPC B60H 1/32011; B60H 1/22; B60H 1/3205; B60H 2001/2246

(57) ABSTRACT

A cabin air control system for a vehicle comprises an air conditioning device having a positive pressure region in communication with a cabin, and a negative pressure region in selective communication with the cabin and/or outside environment via a circulation control device, and an adsorption device comprising a single adsorption assembly and a switching device configured to switch the adsorption device between a standby mode, an adsorption mode and a regeneration mode.

### CROSS-REFERENCE TO RELATED APPLICATION

This application is a continuation application of International Application No. PCT/CN2023/109261 filed on Jul. 26, 2023, the entire disclosure of which is incorporated herein by reference for all purposes.

### BACKGROUND

Embodiments relate to a Heating, Venting, and Air Conditioning (HVAC) system for a vehicle, and more specifically to a cabin air control system for HVAC system.

In most motor vehicles, in order to achieve as many mileages as possible, it is very necessary to save as much energy as possible while the vehicle is driving. Usually, the driver and passengers can adjust the air temperature and humidity of the passenger compartment of the motor vehicle by means of HVAC system for comfort requirements.

The HVAC system can be operated in an external circulation mode or in an air recirculation (i.e., internal circulation) mode. Increasing operating time in recirculation mode by controlling an air conditioning device (regulation of recirculation/recirculation mode), wherein in recirculation operation the air in the passenger compartment is recirculated and is air-conditioned (heated or cooled), will cause the air-conditioning device to draw in as little fresh air as possible from the external environment of the motor vehicle and to heat (in winter) or cool (in summer) the fresh air, and utilize cabin air recirculating by the recirculation mode to adjust the air temperature and humidity of the cabin to achieve desired energy savings.

However, during operation in the above-mentioned recirculation mode, the water vapor exhaled by the driver and passengers will cause fogging on glass (windshield or side windows) of the vehicle, which will bring unpredictable danger to the driver and passengers of the vehicle. If the defogging mode is continuously turned on, it will increase the power consumption and reduce the range of the vehicle, thereby failing to achieve the purpose of energy saving.

Moreover, in the air recirculation mode, the CO2 exhaled by the driver and passengers may also accumulate in the passenger compartment. It will cause the driver to get sleepy during driving, which brings potential danger to the normal operation of the vehicle. For safety of the vehicle operation and the health of the driver and passengers, it is necessary to prevent and reduce the occurrence of this situation, so as to avoid that the driver's concentration may be greatly reduced due to the high concentration of carbon dioxide in the air in the passenger compartment, so as to avoid potential hazard to the normal operation of the vehicles.

At present, there is proposed a double adsorption unit structure including a first adsorption unit and a second adsorption unit. However, the double adsorption unit structure has a large volume, which increases the difficulty of vehicle layout; the weight thereof is heavier, and the double adsorption unit structure itself needs to add more components to strengthen the structure; in addition, the cost is high, and the double adsorption unit requires two heaters and two motors to be managed separately.

To this end, it is desirable to develop a single adsorption unit structure, which ensures performance, has relatively small size, has relatively light weight, uses a single heater and a single motor to achieve operation control, reduces the manufacturing cost, greatly improves the compatibility of the air control system of the vehicle, and at the same time meets the basic function of vehicle energy saving, thereby improving the market competitiveness of the system.

### SUMMARY

Objects of the present disclosure are to provide an integrated cabin air recirculation system, which is simple in structure, reduces the number of components and is easy to assembly.

In one aspect, a cabin air control system is provided. The cabin air control system comprises an air conditioning device having a positive pressure region in communication with a cabin, and a negative pressure region in selective communication with the cabin and/or outside environment via a circulation control device, and an adsorption device comprising a single adsorption assembly and a switching device configured to switch the adsorption device between a standby mode, an adsorption mode and a regeneration mode.

The adsorption assembly comprises a housing, a heater disposed in the housing, and an adsorption unit disposed in the housing and downstream of the heater, the adsorption unit being configured to adsorb moisture and/or carbon dioxide and/or harmful gas, the heater being configured to heat air before being delivered to the adsorption unit when activated, and the heated air being used to regenerate the adsorption unit.

The switching device comprises a first port in communication with an intake passage of the adsorption assembly, a second port in communication with an outlet passage of the adsorption assembly, a third port in communication with an intake pipe connected to the positive pressure region, a fourth port in communication with a return pipe connected to the negative pressure region, and a fifth port in communication with an exhaust pipe.

Preferably, the switching device is configured to, in the standby mode, not connect the first port, the second port, the third port, the fourth port and the fifth port with each other, and the heater is configured to, in the standby mode, be deactivated.

Preferably, the switching device is configured to, in the adsorption mode, connect the first port with the third port, and connect the second port with the fourth port, the circulation control device is configured to, in the adsorption mode, connect the negative pressure region with the cabin, and not connect the negative pressure region with the outside environment, and the heater is configured to, in the adsorption mode, be deactivated.

Preferably, the switching device is configured to, in the regeneration mode, connect the first port with the third port, and connect the second port with the fifth port, the circulation control device is configured to, in the regeneration mode, connect the negative pressure region with the cabin, and connect the negative pressure region with the outside environment, and the heater is configured to, in the regeneration mode, be activated.

Preferably, the air conditioning device further comprises a heat exchange device disposed in the positive pressure region, and a fan dividing the air conditioning device into the positive pressure region and the negative pressure region.

Preferably, the cabin air control system further comprises a controller, a first gas sensor disposed in the intake pipe, a second gas sensor disposed in the return pipe, and a third gas sensor disposed in the exhaust pipe. The first gas sensor is configured to monitor a humidity level and/or a carbon dioxide level and/or a harmful gas level of the intake pipe, the second gas sensor is configured to monitor a humidity level and/or a carbon dioxide level and/or a harmful gas level of the return pipe, the third gas sensor is configured to monitor a humidity level and/or a carbon dioxide level and/or a harmful gas level of the exhaust pipe. The controller is configured to control the switching device, the circulation control device and the heater to operate in the adsorption mode when an output value of the first gas sensor is greater than or equal to a first predetermined threshold, switch to the regeneration mode when an output value of the second gas sensor is greater than or equal to a second predetermined threshold, switch to the adsorption mode when an output value of the third gas sensor is less than a third predetermined threshold, and switch to the standby mode when the output value of the first gas sensor is less than a fourth predetermined threshold less than the first predetermined threshold, the output value of the second gas sensor is less than a fifth predetermined threshold less than the second predetermined threshold, and the output value of the third gas sensor is less than the third predetermined threshold.

Preferably, the controller is further configured to control the switching device, the circulation control device and the heater to operate in advance in the regeneration mode when the vehicle is in a charging state or a ready-to-start state, and switch to the standby mode when the output value of the third gas sensor is less than the third predetermined threshold.

Preferably, the adsorption unit comprises water vapor adsorption material.

Preferably, the adsorption unit comprises carbon dioxide adsorption material.

Preferably, the adsorption unit comprises harmful gas adsorption material.

Preferably, the adsorption assembly further comprises at least one temperature sensor configured to effectively monitor a temperature change of the heater to prevent accidents caused by heater overheating and failure caused by heater failure and to control a regeneration temperature.

In the second aspect, a method of controlling the cabin air control system is provided. The method comprises (a) controlling the switching device, the circulation control device and the heater to operate in the adsorption mode when the output value of the first gas sensor is greater than or equal to the first predetermined threshold, (b) controlling the switching device, the circulation control device and the heater to switch to the regeneration mode when the output value of the second gas sensor is greater than or equal to the second predetermined threshold, (c) controlling the switching device, the circulation control device and the heater to switch to the adsorption mode when the output value of the third gas sensor is less than the third predetermined threshold, and (d) controlling the switching device, the circulation control device and the heater to switch to the standby mode when the output value of the first gas sensor is less than the fourth predetermined threshold, the output value of the second gas sensor is less than the fifth predetermined threshold, and the output value of the third gas sensor is less than the third predetermined threshold.

Preferably, the method further comprises (e) controlling the switching device, the circulation control device and the heater to operate in advance in the regeneration mode when the vehicle is in a charging state or a ready-to-start state, and (f) controlling the switching device, the circulation control device and the heater to switch to the standby mode when the output value of the third gas sensor is less than the third predetermined threshold.

By means of the structure design of the single adsorption unit, the cabin air control system of the embodiments is simple in structure, reduces the number of components and the volume of the cabin air control system and is easy to assembly while ensuring performance of the cabin air control system, which greatly improves the vehicle compatibility of the cabin air control system.

In addition, the cabin air control system of the embodiments operates in advance in the regeneration mode when the vehicle is in a charging state or a ready-to-start state, and then switches to the standby mode when output value of the third gas sensor is less than the third predetermined threshold. This ensures that the cabin air control system can immediately operate in the adsorption mode once the vehicle is started.

In addition, the cabin air control system of the embodiments operates in the standby mode when output value of the first gas sensor is less than a fourth predetermined threshold which is less than the first predetermined threshold, output value of the second gas sensor is less than a fifth predetermined threshold which is less than the second predetermined threshold, and output value of the third gas sensor is less than the third predetermined threshold. This can greatly save energy for operating the adsorption assembly.

In addition, by means of the structure design of the single adsorption unit, the weight of the cabin air control system of the embodiments is relatively light, while ensuring performance of the cabin air control system, which reduces the production cost and facilitates the installation and maintenance of the cabin air control system on the whole vehicle

The cabin air control system is integrated with a temperature sensor, which can effectively monitor temperature change of the heater and to prevent accidents caused by heater overheating and failure caused by heater failure as well as to control regeneration temperature.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings.

FIG. 1 is a schematic diagram of an example vehicle including a cabin air control system of the embodiments.

FIG. 2 is a schematic diagram showing a standby mode of the cabin air control system of the embodiments.

FIG. 3 is a schematic diagram showing an adsorption mode of the cabin air control system of the embodiments.

FIG. 4 is a schematic diagram showing a regeneration mode of the cabin air control system of the embodiments.

### DETAILED DESCRIPTION

As used herein, words such as “up”, “down”, “left”, and “right” used herein to define orientations generally refer to and are understood as orientations in association with the drawings and orientations in actual application.

As used herein, the term “vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, watercraft, aircraft, etc. In an example, an electric vehicle includes a vehicle body with a passenger cabin, multiple road wheels mounted to the vehicle body, and other standard original equipment. An electrified powertrain contains one or more vehicle-mounted traction motors that operate alone (e.g., for FEV powertrains) or in conjunction with an internal combustion engine assembly (e.g., for HEV powertrains) to selectively drive one or more of the road wheels and thereby propel the vehicle.

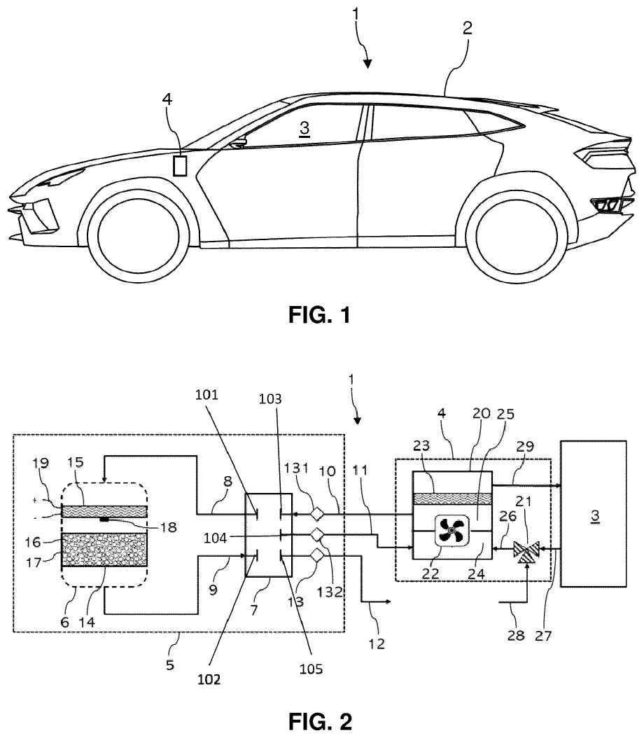

Referring now to the drawings, wherein like reference numbers refer to like features throughout the several views, FIG. 1 is a schematic diagram of an example vehicle 2. The vehicle 2 includes a cabin air control system 1 and a cabin 3. The cabin 3 is an enclosed space.

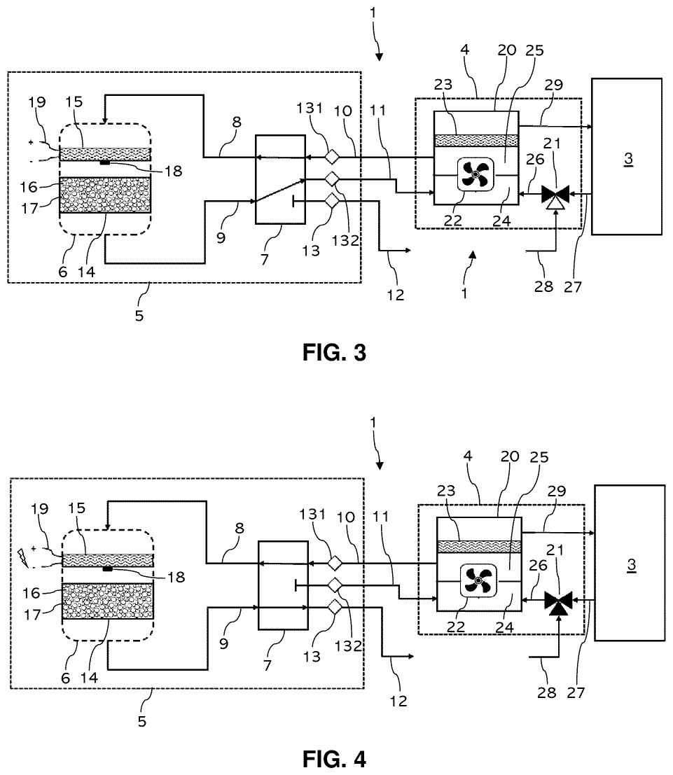

FIG. 2 is a schematic diagram showing a standby mode of the cabin air control system 1 of the embodiments. FIG. 3 is a schematic diagram showing an adsorption mode of the cabin air control system 1 of the embodiments. FIG. 4 is a schematic diagram showing a regeneration mode of the cabin air control system 1 of the embodiments.

The cabin air control system 1 includes an air conditioning device 4 defining a positive pressure region 25 of a temperature adjustment device 20 in communication with the cabin 3 and a negative pressure region 24 of the temperature adjustment device 20 in selective communication with the cabin 3 and/or outside environment via a circulation control device 21.

The air conditioning device 4 includes a heat exchange device 23 disposed in the positive pressure region 25 and a fan 22 dividing the air conditioning device 4 into the positive pressure region 25 and the negative pressure region 24. The heat exchange device 23 is used to adjust the air temperature in the cabin 3. At the same time, the heat exchange device 23 can provide dehumidification function as demanded. The fan 22 is used to provide power for air flow. The air conditioning device 4 may comprise other components as needed, such as at least one sensor, etc., without departing the scope of the disclosure.

The circulation control device 21 is connected to a suction passage 26, the internal circulation channel 27, and the external circulation channel 28. The internal circulation channel 27 is connected to the circulation control device 21 at one end thereof and is connected to an enclosed air volume/cabin 3 at the other end thereof. The internal circulation channel 27 is used to convey gas into the temperature adjustment device 20. A return air passage 29 is disposed at the rear end of the heat exchange device 23 of the air temperature adjustment device 20, and the return air passage 29 connects the air temperature adjustment device 20 and the enclosed air volume/cabin 3. The return air passage 29 is configured to convey conditioned air back into the enclosed air volume/cabin 3 for the comfort of the driver and passengers.

The cabin air control system 1 further includes an adsorption device 5 including a single adsorption assembly 6 and a switching device 7 configured to switch the adsorption device 5 between a standby mode, an adsorption mode and a regeneration mode. The cabin air control system 1 may comprise other components as needed, such as a controller, at least one sensor, etc., without departing the scope of the disclosure. By means of the structure design of the single adsorption assembly 6, the cabin air control system 1 of the embodiments is simple in structure, reduces the number of components and the volume of the cabin air control system 1 and is easy to assembly while ensuring performance of the cabin air control system 1, which greatly improves the vehicle compatibility of the cabin air control system 1. In addition, by means of the structure design of the single adsorption assembly 6, the weight of the cabin air control system 1 of the embodiments is relatively light, while ensuring performance of the cabin air control system 1, which reduces the production cost and facilitates the installation and maintenance of the cabin air control system 1 on the whole vehicle. The cabin air control system 1 of the embodiments adopts a single heater to realize operational control, which reduces the cost of the cabin air control system 1 and enhances the market competitiveness of the cabin air control system 1.

The adsorption assembly 6 includes: a housing, a heater 15 disposed in the housing, an adsorption unit 14 disposed in the housing downstream of the heater 15. The adsorption unit 14 is configured to adsorb moisture and/or carbon dioxide and/or harmful gas. For example, the adsorption unit 14 may include water vapor adsorption material 16; and/or carbon dioxide adsorption material 17; and/or harmful gas adsorption material. As a non-limiting example, the adsorption material may include resin, which has a certain adsorption capacity at room temperature, and has desorption ability at a temperature of 80-120° C. By using the properties of low-temperature adsorption and high-temperature desorption of resin, the air quality in the cabin 3 is well controlled. However, as will be understood by those skilled in the art, the adsorption material may be made from any suitable material, without departing the scope of the disclosure.

The heater 15 is configured to heat air before being delivered to the adsorption unit 14 when activated, and the heated air being used to regenerate the adsorption unit 14. The heater 15 includes power lines 19 for powering the heater 15. In addition, the heater 15 includes at least one temperature sensor 18, which can effectively monitor the temperature change of the heater 15 and prevent accidents caused by heater overheating and failure caused by heater failure as well as control regeneration temperature. As a non-limiting example, the heater 15 includes two temperature sensors 18. However, as will be understood by those skilled in the art, the heater 15 may include any suitable number of temperature sensors 18, without departing the scope of the disclosure.

By means of the structure design of the single adsorption unit, the cabin air control system 1 of the embodiments is simple in structure, reduces the number of components and the volume of the cabin air control system 1 and is easy to assembly while ensuring performance of the cabin air control system, which greatly improves the vehicle compatibility of the cabin air control system 1.

As shown in FIG. 2, the switching device 7 is provided with a first port 101 in communication with an intake passage 8 of the adsorption assembly 6; a second port 102 in communication with an outlet passage 8 of the adsorption assembly 6; a third port 103 in communication with an intake pipe 10 connected to the positive pressure region 25; a fourth port 104 in communication with a return pipe 11 connected to the negative pressure region 24; and a fifth port 105 in communication with an exhaust pipe 12.

In the standby mode, the switching device 7 is configured so that the first port, the second port, the third port, the fourth port and the fifth port are not in communication with each other, and the heater 15 is deactivated.

In the adsorption mode, the switching device 7 is configured so that the first port is in communication with the third port, and the second port is in communication with the fourth port, the circulation control device 21 is configured so that the negative pressure region 24 is in communication with the cabin 3 and is not in communication with the outside environment, and the heater 15 is deactivated.

In the regeneration mode, the switching device 7 is configured so that the first port is in communication with the third port, and the second port is in communication with the fifth port, the circulation control device 21 is configured so that the negative pressure region 24 is in communication with the cabin 3 and is in communication with the outside environment, and the heater 15 is activated.

The cabin air control system 1 further comprising a controller (not shown), a first gas sensor 131 disposed in the intake pipe 10, a second gas sensor 132 disposed in the return pipe 11, and a third gas sensor 13 disposed in the exhaust pipe 12. The first gas sensor 131 being configured to monitor the humidity level and/or carbon dioxide level and/or harmful gas level of the intake pipe 10. The second gas sensor 132 is configured to monitor the humidity level and/or carbon dioxide level and/or harmful gas level of the return pipe 11. The third gas sensor 13 is configured to monitor the humidity level and/or carbon dioxide level and/or harmful gas level of the exhaust pipe 12.

The controller is configured to control the switching device 7, the circulation control device 21 and the heater 15 to operate in the adsorption mode when output value of the first gas sensor 131 is greater than or equal to a first predetermined threshold; to control the switching device 7, the circulation control device 21 and the heater 15 to switch to the regeneration mode when output value of the second gas sensor 132 is greater than or equal to a second predetermined threshold; to switch to the adsorption mode when output value of the third gas sensor 13 is less than a third predetermined threshold; and to switch to the standby mode when output value of the first gas sensor 131 is less than a fourth predetermined threshold which is less than the first predetermined threshold, output value of the second gas sensor 132 is less than a fifth predetermined threshold which is less than the second predetermined threshold, and output value of the third gas sensor 13 is less than the third predetermined threshold.

The controller is configured to control the switching device 7, the circulation control device 21 and the heater 15 to operate in advance in the regeneration mode when the vehicle is in a charging state or a ready-to-start state; and to switch to the standby mode when output value of the third gas sensor 13 is less than the third predetermined threshold.

A method of controlling the cabin air control system 1 comprises the steps of:

(a) controlling the switching device 7, the circulation control device 21 and the heater 15 to operate in the adsorption mode when output value of the first gas sensor 131 is greater than or equal to a first predetermined threshold. The heater 15 is deactivated or in a non-working state, and the circulation control device 21 disconnects the external circulation channel 28 with the suction passage 26 and is in an internal circulation mode (a recirculated mode. The suction passage 26 is only connected to the internal circulation channel 27. The recirculated air in the enclosed air volume/cabin 3 pass through the fan 22 in the temperature adjustment device 20. A portion of the air passes through the intake pipe 10, the switching device 7 and the intake passage 8. The adsorption assembly 6 absorbs carbon dioxide, water and harmful gases in the air by the adsorption unit 14. The clean air that has undergone adsorption treatment returns to the negative pressure region 24 of the temperature adjustment device 20 and mixes with the remaining portion of the air, and then returns to the closed air volume/cabin 3 by the return air passage 29.

(b) controlling the switching device 7, the circulation control device 21 and the heater 15 to switch to the regeneration mode when output value of the second gas sensor 132 is greater than or equal to a second predetermined threshold. The circulation control device 21 communicates the suction passage 26 with the external circulation channel 28 to adjust the mixing ratio of the external air according to the concentration information of carbon dioxide, water vapor and harmful gases in the enclosed air volume/cabin 3. The mixed air passes through the fan 22 of the temperature adjustment device 20. A portion of the conditioned air is transported to the adsorption assembly 6 via the intake pipe 10, the switching device 7 and the intake passage 8. At the same time, the heater 15 is activated, to heat the air entering the adsorption assembly 6 to provide the high-temperature gas required for regeneration of the adsorption unit 14. The regenerated air is discharged into the external environment by passing through the outlet passage 9, the switching device 7 and the exhaust pipe 12. The rest of the conditioned air is returned to the enclosed air volume/cabin 3 through the return air passage 29, so as to ensure that the concentration of carbon dioxide, water vapor and harmful gas in the enclosed air volume/cabin 3 is in a safe scope.

(c) switching to the adsorption mode when output value of the third gas sensor 13 is less than a third predetermined threshold.

(d) switching to the standby mode when output value of the first gas sensor 131 is less than a fourth predetermined threshold which is less than the first predetermined threshold, output value of the second gas sensor 132 is less than a fifth predetermined threshold which is less than the second predetermined threshold, and output value of the third gas sensor 13 is less than the third predetermined threshold.

The method further comprises the steps of:

(e) controlling the switching device 7, the circulation control device 21 and the heater 15 to operate in advance in the regeneration mode when the vehicle is in a charging state or a ready-to-start state; and

(f) switching to the standby mode when output value of the third gas sensor 13 is less than the third predetermined threshold.

The cabin air control system 1 of the embodiments operates in advance in the regeneration mode when the vehicle is in a charging state or a ready-to-start state, and then switches to the standby mode when output value of the third gas sensor is less than the third predetermined threshold. This ensures that the cabin air control system can immediately operate in the adsorption mode once the vehicle is started.

In addition, the cabin air control system of the embodiments operates in the standby mode when output value of the first gas sensor is less than a fourth predetermined threshold which is less than the first predetermined threshold, output value of the second gas sensor is less than a fifth predetermined threshold which is less than the second predetermined threshold, and output value of the third gas sensor is less than the third predetermined threshold. This can greatly save energy for operating the adsorption assembly.

The cabin air control system 1 is integrated with a temperature sensor 18, which can effectively monitor temperature change of the heater and to prevent accidents caused by heater overheating and failure caused by heater failure as well as to control regeneration temperature.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

1. A cabin air control system for a vehicle, the cabin air control system comprising:
an air conditioning device having a positive pressure region in communication with a cabin, and a negative pressure region in selective communication with the cabin and/or outside environment via a circulation control device; and
an adsorption device comprising a single adsorption assembly and a switching device configured to switch the adsorption device between a standby mode, an adsorption mode and a regeneration mode,
wherein the adsorption assembly comprises:
a housing;
a heater disposed in the housing; and
an adsorption unit disposed in the housing and downstream of the heater, the adsorption unit being configured to adsorb moisture and/or carbon dioxide and/or harmful gas, the heater being configured to heat air before being delivered to the adsorption unit when activated, and the heated air being used to regenerate the adsorption unit, and
the switching device comprises:
a first port in communication with an intake passage of the adsorption assembly;
a second port in communication with an outlet passage of the adsorption assembly;
a third port in communication with an intake pipe connected to the positive pressure region;
a fourth port in communication with a return pipe connected to the negative pressure region; and
a fifth port in communication with an exhaust pipe.

2. The cabin air control system according to claim 1, wherein the switching device is configured to, in the standby mode, not connect the first port, the second port, the third port, the fourth port and the fifth port with each other, and
the heater is configured to, in the standby mode, be deactivated.

3. The cabin air control system according to claim 2, wherein the switching device is configured to, in the adsorption mode, connect the first port with the third port, and connect the second port with the fourth port,
the circulation control device is configured to, in the adsorption mode, connect the negative pressure region with the cabin, and not connect the negative pressure region with the outside environment, and
the heater is configured to, in the adsorption mode, be deactivated.

4. The cabin air control system according to claim 3, wherein the switching device is configured to, in the regeneration mode, connect the first port with the third port, and connect the second port with the fifth port,
the circulation control device is configured to, in the regeneration mode, connect the negative pressure region with the cabin, and connect the negative pressure region with the outside environment, and
the heater is configured to, in the regeneration mode, be activated.

5. The cabin air control system according to claim 1, wherein the air conditioning device further comprises a heat exchange device disposed in the positive pressure region, and a fan dividing the air conditioning device into the positive pressure region and the negative pressure region.

6. The cabin air control system according to claim 1, further comprising:
a controller;
a first gas sensor disposed in the intake pipe;
a second gas sensor disposed in the return pipe; and
a third gas sensor disposed in the exhaust pipe,
wherein the first gas sensor is configured to monitor a humidity level and/or a carbon dioxide level and/or a harmful gas level of the intake pipe,
the second gas sensor is configured to monitor a humidity level and/or a carbon dioxide level and/or a harmful gas level of the return pipe,
the third gas sensor is configured to monitor a humidity level and/or a carbon dioxide level and/or a harmful gas level of the exhaust pipe, and
the controller is configured to control the switching device, the circulation control device and the heater to:
operate in the adsorption mode when an output value of the first gas sensor is greater than or equal to a first predetermined threshold;
switch to the regeneration mode when an output value of the second gas sensor is greater than or equal to a second predetermined threshold;
switch to the adsorption mode when an output value of the third gas sensor is less than a third predetermined threshold; and
switch to the standby mode when the output value of the first gas sensor is less than a fourth predetermined threshold less than the first predetermined threshold, the output value of the second gas sensor is less than a fifth predetermined threshold less than the second predetermined threshold, and the output value of the third gas sensor is less than the third predetermined threshold.

7. The cabin air control system according to claim 6, wherein the controller is further configured to control the switching device, the circulation control device and the heater to:
operate in advance in the regeneration mode when the vehicle is in a charging state or a ready-to-start state; and
switch to the standby mode when the output value of the third gas sensor is less than the third predetermined threshold.

8. The cabin air control system according to claim 1, wherein the adsorption unit comprises water vapor adsorption material.

9. The cabin air control system according to claim 1, wherein the adsorption unit comprises carbon dioxide adsorption material.

10. The cabin air control system according to claim 1, wherein the adsorption unit comprises harmful gas adsorption material.

11. The cabin air control system according to claim 1, wherein the adsorption assembly further comprises at least one temperature sensor configured to effectively monitor a temperature change of the heater to prevent accidents caused by heater overheating and failure caused by heater failure and to control a regeneration temperature.

12. A method of controlling the cabin air control system according to claim 6, the method comprising:
controlling the switching device, the circulation control device and the heater to operate in the adsorption mode when the output value of the first gas sensor is greater than or equal to the first predetermined threshold;
controlling the switching device, the circulation control device and the heater to switch to the regeneration mode when the output value of the second gas sensor is greater than or equal to the second predetermined threshold;
controlling the switching device, the circulation control device and the heater to switch to the adsorption mode when the output value of the third gas sensor is less than the third predetermined threshold; and
controlling the switching device, the circulation control device and the heater to switch to the standby mode when the output value of the first gas sensor is less than the fourth predetermined threshold, the output value of the second gas sensor is less than the fifth predetermined threshold, and the output value of the third gas sensor is less than the third predetermined threshold.

13. The method according to claim 10, further comprising:
controlling the switching device, the circulation control device and the heater to operate in advance in the regeneration mode when the vehicle is in a charging state or a ready-to-start state; and
controlling the switching device, the circulation control device and the heater to switch to the standby mode when the output value of the third gas sensor is less than the third predetermined threshold.
